(19) United States
(12) Patent Application Publication
(10) Pub. No.: US 2003/0072101 A1
(43) Pub. Date: Apr. 17, 2003

(54) Servo data writing apparatus and servo data writing method

(75) Inventors: Atsushi Takeichi, Fujisawa-shi (JP); Hirofumi Yanase, Fujisawa-shi (JP)

Correspondence Address: IBM Corporation, Intellectual Property Law, 5600 Cottle Road (L2PA/0142), San Jose, CA, 95193, US

(73) Assignee: International Business Machines Corporation, Armonk, NY

(21) Appl. No.: 10/264,714

(22) Filed: Oct. 4, 2002

(30) Foreign Application Priority Data
Oct. 4, 2001 (JP) 2001-309019

(51) Int. Cl. G11B 21/02; G11B 5/596

(52) U.S. Cl. 360/75; 360/77.08

(57) ABSTRACT

A servo data writing method for employing a head to write servo data that identifies the positions of multiple tracks formed on a recording medium having a disk shape, comprises the steps of: detecting a vibration that is caused by the rotation of the recording medium; and writing servo data while permitting the head to follow the vibration.

### BACKGROUND OF THE INVENTION

1. Field of the Invention

The present invention relates to a method and an apparatus for writing servo data to a recording medium.

2. Background Art

A hard disk drive has magnetic heads for reading user data from a magnetic disk, or for writing user data thereto. These magnetic heads are mounted on an actuator mechanism that is driven by a VCM (Voice Coil Motor). When a magnetic head reads or writes user data, the actuator mechanism is driven and moves and positions the magnetic head above a predetermined track. For the moving and the positioning of the magnetic head at a predetermined location, servo data recorded on the magnetic disk is employed.

On a magnetic disk, such as one in a hard disk drive, multiple data tracks are concentrically formed, and identification data and a burst pattern are stored in advance in the radial direction of the disk. This identification data and the burst patterns constitute the servo data. The identification data represents the track addresses of the data tracks, and based on the identification data read by a magnetic head, the rough position of the magnetic head, i.e., the position of a magnetic head relative to a data track, can be determined. A burst pattern includes multiple burst pattern arrays wherein signal storage areas, the phases of which differ, are arranged at predetermined intervals in the radial direction of the disk. A signal output by a magnetic head in accordance with a burst pattern can be employed to detect even a slight position shift of the magnetic head, i.e., a deviation wherein the position of the magnetic head is shifted away from a data track relative to the magnetic head.

To read user data from or write user data to a magnetic disk, first, while the magnetic disk is rotating, identification data read from the magnetic head is employed to determine the rough position of the magnetic head, and the magnetic head is driven to move it to a specific data track. Then, a signal output by the magnetic head in accordance with the burst pattern is employed to precisely position the magnetic head relative to the specific data track. Finally, data can be read from or written to the magnetic disk. This process sequence is called a seek mode. Further, the feedback control is performed so that even during the reading or writing of user data, based on a signal that is output by the magnetic head in accordance with the burst pattern, the magnetic head can be positioned at a constant location relative to a specific data track. This operation is called a following mode.

During the manufacturing process performed before a hard disk drive is shipped as a finished product, servo data is written to a magnetic disk constituting a recording medium. In order later for user data to be accurately written to or read from the recording medium, the writing of the servo data must be free of errors.

A servo track writer (STW) writes servo data to a magnetic disk while the disk is being rotated. Thus, one of the problems encountered when an STW is used to write servo data is that as the magnetic disk is rotated it produces vibrations. Now, supposing that no vibrations were to occur when the magnetic disk was rotated, as is shown in FIG. 9, a servo data writing trajectory a would correspond to a circle formed around the rotational center of the magnetic disk. However, since in actuality the magnetic disk would vibrate, the circle described by the trajectory a would not be obtained. Especially, were the magnetic disk to vibrate forcefully, following one revolution, as is indicated by a trajectory b in FIG. 9, the servo data write end position for the magnetic disk would be noticeably shifted radially from the write start position. This shift is called a “jump”. If a jump occurs during a user data writing or reading process, servo data for a magnetic disk can not be employed to precisely position a magnetic head. Therefore, servo data must be so written that it prevents the occurrence of jumps.

An effective method for preventing the occurrence of jumps is disclosed in Japanese Unexamined Patent Publication No. Hei 11-25624. According to this method, as a magnetic disk is rotated the vibrations thus generated are detected. Then, the detected vibrations are employed to extract, from vibrations (NRROs) that are not synchronized with the rotation of the magnetic disk, a vibration caused by a predetermined frequency element. The vibration caused by the extracted, predetermined frequency element is employed to select the servo data write start point, so as to minimize the difference between the value of the vibration that is caused by the predetermined frequency element when the servo data writing is initiated, and the value of the vibration that is caused by the predetermined frequency element when the magnetic disk has been rotated one time. Then, when the selected write start point is reached, the writing means will begin to record servo data on the magnetic disk. Therefore, between the servo data write start position and the write end position, the position shift that is attributable to the vibration of the magnetic disk as it rotates can be suppressed to the extent possible, and the magnetic head can be precisely positioned for the writing or the reading of user data.

FIG. 10 is a diagram showing the servo data writing trajectory in FIG. 9 that is extended linearly. In FIG. 10, the horizontal axis represents the circumferential direction of the magnetic disk, and the vertical axis represents the radial direction of the magnetic disk. Further, in FIG. 10, solid lines describe a circle formed at the rotational center of the magnetic disk, while chain lines describe the servo data writing trajectory.

When no magnetic disk vibrations occur, the servo data writing trajectory follows the solid line in FIG. 10. However, since vibrations are actually induced, the servo data writing trajectory is as indicated by the chain lines. For the writing or reading of user data, the servo data writing trajectory described by the chain lines is regarded as the center of a track. As is shown in FIG. 10, the interval between the adjacent chain lines varies, and the portion whereat the interval between the servo data writing trajectories is narrower indicates that the interval between the tracks is smaller than for the other portions. Therefore, at this narrower portion, a squeeze phenomenon may occur whereby the magnetic pattern of an adjacent track is re-magnetized when user data is to be written.

The method disclosed in Japanese Unexamined Patent Publication No. Hei 11-25624 is extremely effective in suppressing the occurrences of jumps, but it can not cope with irregularities in the track intervals. It is, therefore, one object of the present invention to provide a servo data writing apparatus and a servo data writing method for suppressing both the occurrences of jumps and the variances in the intervals between the servo data writing trajectories.

### SUMMARY OF THE INVENTION

There are roughly two types of vibrations experienced by a rotating magnetic disk. One type of vibration is an RRO (Repeatable Run Out) and the other is an NRRO (Non Repeatable Run Out). An RRO vibration is one that is synchronized with the rotation of the magnetic disk, and an NRRO vibration is one that is not synchronized with the rotation of the magnetic disk. For an RRO vibration, the position of the magnetic disk is not shifted relative to the servo data writing head, while for an NRRO vibration, the position of a magnetic disk is shifted relative to the head. It can be that this positioning shift occurs because the head is conventionally fixed in a predetermined position, and that when the positioning of the head is performed in accordance with an NRRO vibration, a shift in position between the magnetic disk and the head does not occur.

The present invention is based on the above viewpoint. According to one aspect of the present invention, a servo data writing apparatus for writing, via a write head, servo data that identifies the positions of multiple tracks formed on a recording medium having a disk shape comprises: a positioner for, before writing the servo data, moving the write head in the radial direction of the recording medium; and a controller for, when the position of the recording medium changes relative to the position of the write head as the recording medium is rotated, permitting the positioner to move the write head in the radial direction of the recording medium while the servo data is being written.

According to the present invention, as the position of the rotating recording medium is changed relative to the position of the write head, the servo data writing apparatus permits the positioner to move the write head in the radial direction of the recording medium before any of the servo data is written. Therefore, since the shift between the positions of the recording medium and the write head can be prevented, the occurrence of a jump along the servo data writing trajectory is suppressed. Furthermore, since the servo data is so written while taking into account the relative positional change between the recording medium and the write head, variations in the trajectory intervals between adjacent tracks can also be prevented. According to the servo data writing apparatus of the invention, in order to obtain the positional relationship between the recording medium as it is rotated and the write head, first preliminary position data is written to the recording medium before the writing of the servo data is initiated. To write the preliminary position data, the write head is fixed in a predetermined location. Then, after the position of the write head has been appropriately adjusted, the preliminary position data is read from the recording medium, so that the positional relationship between the recording medium and the write head can be obtained. Management of these control processes is provided by the controller of the invention.

Further, to achieve the above object, according to another aspect of the present invention, a servo data writing apparatus for writing servo data that identifies the positions of multiple tracks formed on a recording medium having a disk shape comprises: a head for, before writing the servo data to the recording medium, writing a predetermined burst pattern on the recording medium, and for reading the burst pattern from the recording medium; vibration detection means for employing the burst pattern read by the head to detect vibrations that occur as the recording medium is rotated, and for decreasing, from the detected vibration, the element of a synchronous vibration that is synchronized with the rotation of the recording medium to obtain an element of an asynchronous vibration that is not synchronized with the rotation of the recording medium; and a controller for vibrating the head so as to follow the element of the asynchronous vibration that is detected by the detection means.

To write servo data, the servo data writing apparatus can vibrate the head so as to follow the element of the asynchronous vibration that is detected by the detection means. Therefore, since the shift between the positions of the recording medium and the head can be prevented, the occurrence of a jump along the servo data writing trajectory can be suppressed. And in addition, since the servo data is written to the recording medium while taking into account the positional relationship between the recording medium and the head, the interval variations between the trajectories of adjacent tracks can be prevented.

As a more specific mode for the invention, the vibration detection means employs the element of the asynchronous vibration to obtain the frequency and the amplitude of the asynchronous vibration. The controller can then vibrate the head based on the frequency and the amplitude that are obtained.

In the servo data writing apparatus of the invention, it is preferable that the controller adjust the phase of the element of the asynchronous vibration of the recording medium that is rotated and the phase of the vibration at the head before permitting the head to write the servo data. To adjust the phases, the total of the element of the asynchronous vibration of the recording medium and the vibration of the head need only be minimized. This is because if the phases differ, even though the frequencies and the amplitudes match, the position of the recording medium would be shifted away from the position of the write head.

Additionally provided is the following appropriate servo data writing method for the above described servo data writing apparatus. According to the present invention, a servo data writing method for employing a head to write servo data that identifies the positions of multiple tracks formed on a recording medium having a disk shape comprises the steps of: obtaining the positional relationship, in the radial direction of the recording medium, of a head and the recording medium that is rotated; and controlling the positioning of the head in the radial direction in accordance with the positional relationship, and writing the servo data to the recording medium. According to the servo data writing method of the invention, the positioning of the head is controlled in accordance with the positional relationship existing between the head and the recording medium, and the servo data is written to the recording medium after the head that is to be used to write the servo data has been positioned. Therefore, since the shift between the positions of the recording medium and the head can be prevented, the occurrence of a jump along the servo data writing trajectory can be suppressed. Further, since the servo data is written while taking into account the positional relationship existing between the recording medium and the head, variances in the interval between the trajectories of the adjacent tracks can be prevented.

According to the servo data writing method of the invention, preliminary position data is written while the position of the head is fixed in the radial direction, and the positional relationship is obtained by reading the preliminary position data. More specifically, the preliminary position data is read to obtain a first vibration element that is caused by the recording medium when the preliminary data is written. A second vibration element that is synchronously caused by the rotation of the recording medium is then decreased relative to the first vibration element to obtain a third vibration element, which corresponds to an NRRO and represents the positional relationship. According to the invention, the third vibration element is thereafter employed to obtain a frequency and an amplitude that represent the positional relationship existing in the radial direction between the head and the recording medium that is being rotated. Then, to control the position of the head, it is preferable that a vibration generated at the frequency and the amplitude be provided for the head, and that servo data be written while a predetermined synchronization is obtained between the vibration of the head and the vibration of the recording medium that is rotated.

Through the above explanation, it can be understood that according to the present invention a servo data writing method, for using a head to write servo data that identifies the positions of multiple tracks formed on a recording medium in a disk shape, comprises the steps of: detecting a vibration caused by rotating the recording medium; and writing the servo data while permitting the head to follow the vibration. The vibration to be followed includes a vibration that is not synchronized with the rotation of the recording medium.

### BRIEF DESCRIPTION OF THE DRAWINGS

FIG. 1 is a block diagram showing the configuration of a servo track writer according to one embodiment of the present invention;

FIG. 2 is a conceptual diagram showing the contents stored on a magnetic disk according to the embodiment;

FIG. 3 is a conceptual diagram showing the contents stored on the magnetic disk according to the embodiment;

FIG. 4 is a flowchart showing the servo data writing processing performed according to the embodiment;

FIGS. 5A and 5B are diagrams for explaining the writing and the reading of preliminary burst patterns according to the embodiment;

FIG. 6 is a flowchart showing the phase adjustment processing according to the embodiment;

FIG. 7 is a flowchart showing the servo data writing processing performed according to the embodiment;

FIG. 8 is a flowchart showing the phase adjustment processing performed according to the embodiment;

FIG. 9 is a diagram showing a servo data writing trajectory;

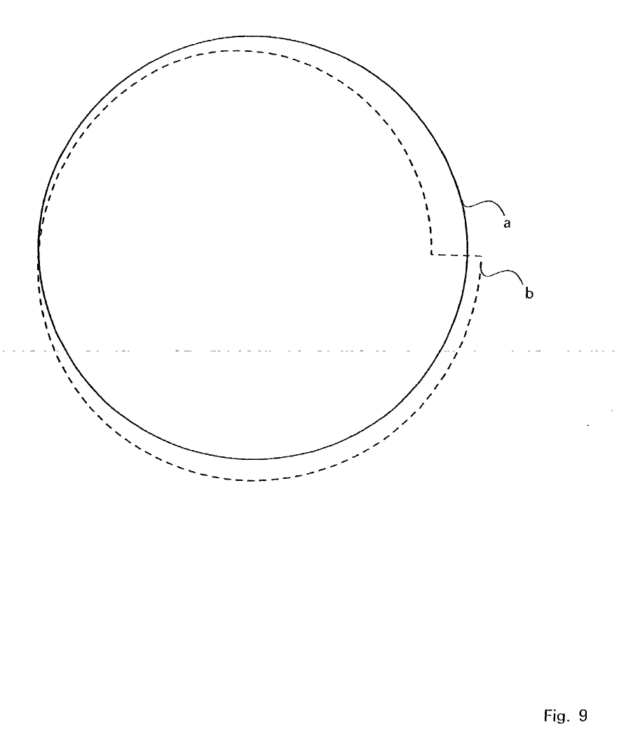

FIG. 10 is a diagram showing the servo data writing trajectory.

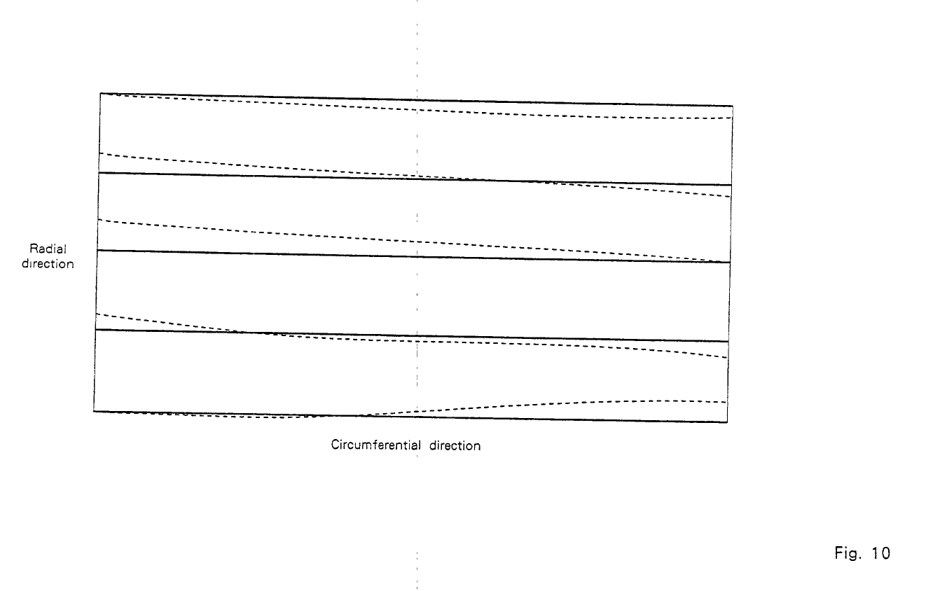

### DETAILED DESCRIPTION OF THE PREFERRED EMBODIMENTS

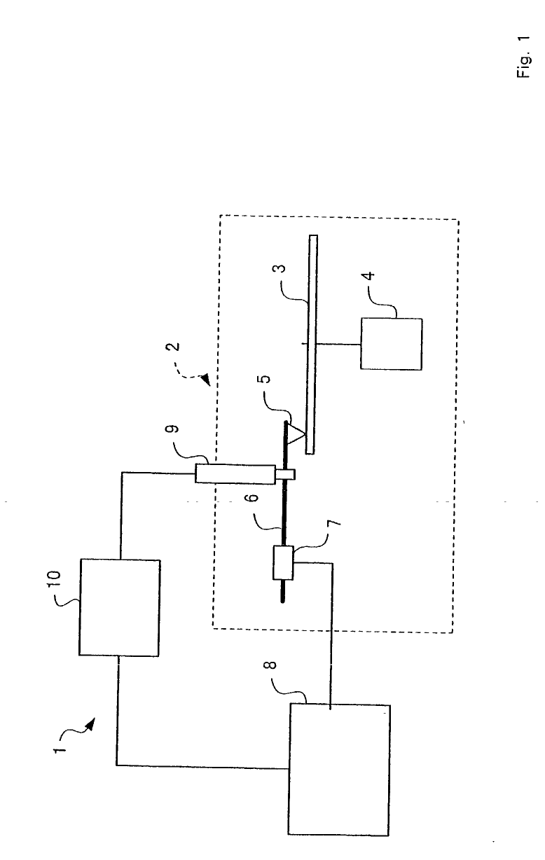

The preferred embodiment of the present invention will now be described while referring to the accompanying drawings. FIG. 1 is a specific diagram showing a servo track writer 1 that implements a servo data writing method according to the embodiment of the invention. The servo track writer 1 comprises a recording controller 8, a head positioner 9 and a position controller 10, and writes servo data to a magnetic disk 3 that constitutes a hard disk drive 2.

The hard disk drive 2 includes a magnetic disk 3 for writing user data, a spindle motor 4 for rotating the magnetic disk 3, a magnetic head 5 for writing user data to the magnetic disk 3 or reading user data therefrom, an arm 6 for supporting the magnetic head 5, and a voice coil motor 7 for moving the arm 6. When user data is to be written to or read from the magnetic disk 3 of the hard disk drive 2, the magnetic head 5 is moved across the magnetic disk 3 by the voice coil motor 7. The hard disk drive 2 may include multiple magnetic disks 3, but only one magnetic disk 3 is shown in FIG. 1. The servo track writer 1 employs the magnetic head 5 of the hard disk drive 2 to write the servo data to the magnetic disk 3. Therefore, the components of the hard disk drive 2 also constitute the servo track writer 1.

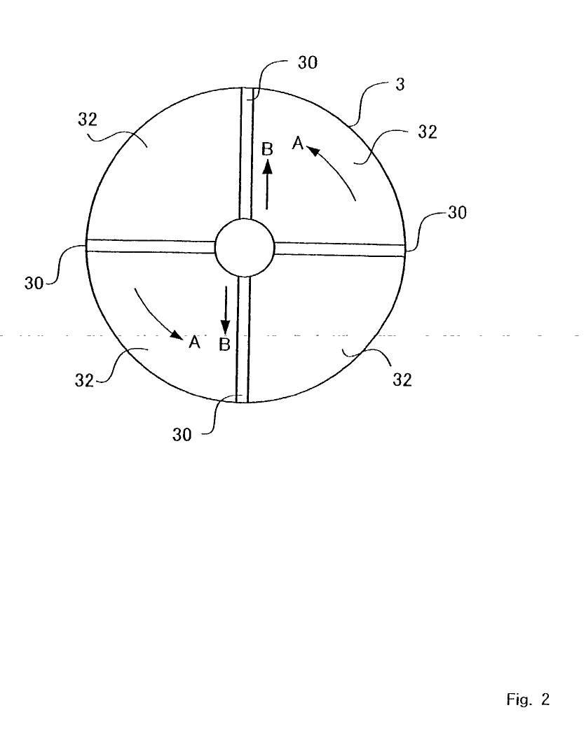

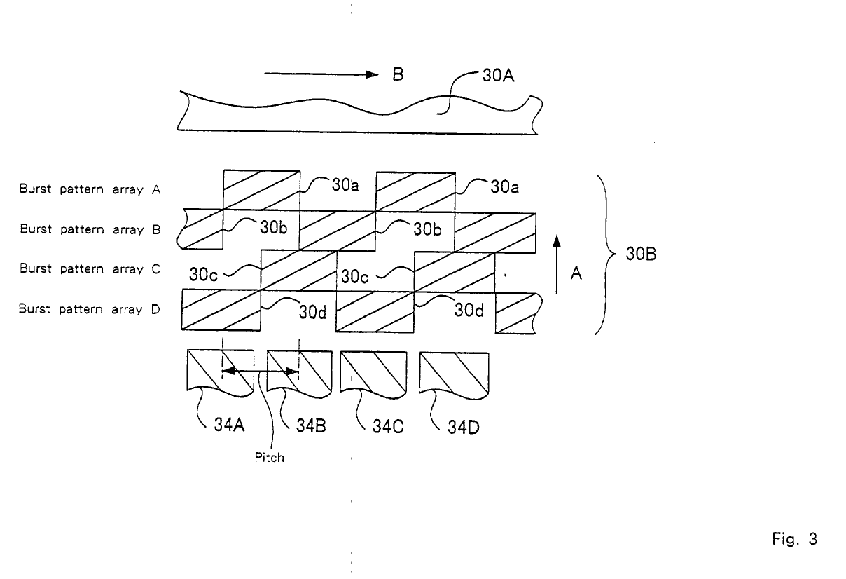

Multiple tracks are concentrically formed on the magnetic disk 3. Each track is divided into multiple sectors consisting of pairs of servo sectors and data sectors. The servo sectors are areas for storing servo data to identify the position on the track. This servo data is written by the magnetic head 5 of the servo track writer 1. The writing of the servo data will be described later. When the hard disk drive 2 is driven, the magnetic disk 3 is rotated at the spindle shaft of the spindle motor 4, and when the hard disk drive 2 is inactive, the magnetic disk 3 is halted (is stationary). As is shown in FIG. 2, on each recording face of the magnetic disk 3, multiple position detection data storage areas 30 are formed radially in the radial direction of the magnetic disk 3 (direction indicated by an arrow B in FIG. 2), and the remaining areas are defined as data track areas 32. In FIG. 3, part of the position detection data storage area 30 and the data track area 32 are shown. Multiple data tracks are formed concentrically at set pitches in the data rack area 32, and part of these tracks, i.e., data tracks 34A, 34B, 34C and 34D, are shown in FIG. 3. The magnetic head 5, which will be described later, reads or writes data along each data track 34 in the circumferential direction (direction indicated by an arrow A in FIGS. 2 and 3) of the magnetic disk 3.

A track identification data storage area 30A and a burst pattern storage area 30B are formed in the position detection data storage area 30. In the track identification data storage area 30A, track identification data, which represents the track address of each data track 34 by using a Gray code (cyclic binary code), is stored in consonance with each data track 34. Further, a burst pattern is formed in the burst pattern storage area 30B. As is shown in FIG. 3, the burst pattern consists of four burst pattern arrays A to D wherein signal storage areas (hatched portions in FIG. 3) are arranged in the direction in which the data tracks 34 are positioned, i.e., in the radial direction of the magnetic disk 3. For the individual signal storage areas constituting each burst pattern array, the size of the signal storage area and the interval between the adjacent areas in the radial direction of the magnetic disk 3 are equal to the pitch of the data tracks 34.

The signal storage areas 30a of the burst pattern array A, and the signal storage areas 30b of the burst pattern array B are arranged in a zigzag shape in the radial direction of the magnetic disk 3. The sides at both ends of each area in the radial direction of the disk correspond to the widthwise center portion of a data track 34, and the burst pattern arrays A and B are formed by storing a signal in each area. The signal storage areas 30c of the burst pattern array C and the signal storage areas 30d of the burst pattern array D are also arranged in a zigzag shape in the radial direction of the magnetic disk 3. Further, the sides at both ends of each area in the radial direction of the disk correspond to boundaries between the data tracks 34, and the burst pattern arrays C and D are formed by storing a signal in each area.

When the magnetic head 5 is used as the hard disk drive 2, as is described above, the magnetic head 5 writes or reads user data relative to the magnetic disk 3. When the magnetic head 5 is used as the servo track writer 1, the magnetic head 5 writes the servo data to the servo track. Further, the magnetic head 5 writes a preliminary burst pattern, which will be described later, that differs from the servo data. Based on the pattern of the preliminary burst, the operation of the magnetic head 5 is controlled for the writing of servo data.

The head positioner 9 guides the magnetic head 5 when servo data is to be written to a predetermined servo track. The head positioner 9 also has a positioning function for halting, at a predetermined position, the magnetic head 5 that has been guided. As will be described later, in the servo track writer 1 in this embodiment, before writing servo data, the head positioner 9 moves the magnetic head 5 to follow the vibration of the magnetic disk 3. The head positioner 9 also drives the magnetic head 5 based on an instruction received from the positioner controller 10.

The recording controller 8 controls the writing of a preliminary burst pattern to the magnetic head 5 or the reading of the preliminary burst pattern therefrom. Further, the recording controller 8 also instructs the positioner controller 10 to drive the head positioner 9. Upon receiving this instruction, the positioner controller 10 controls the operation of the head positioner 9. The recording controller 8 also controls the writing of servo data using the magnetic head 5.

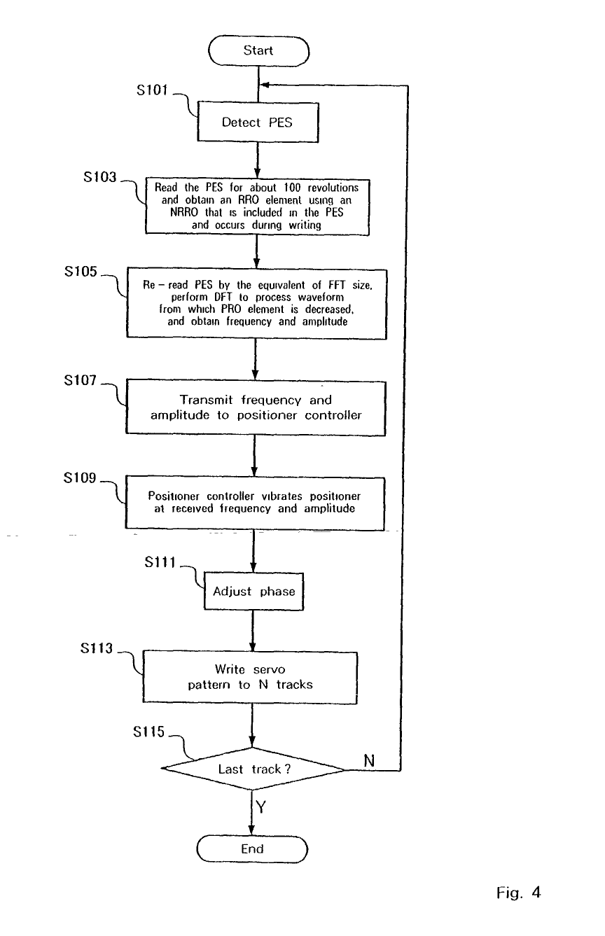

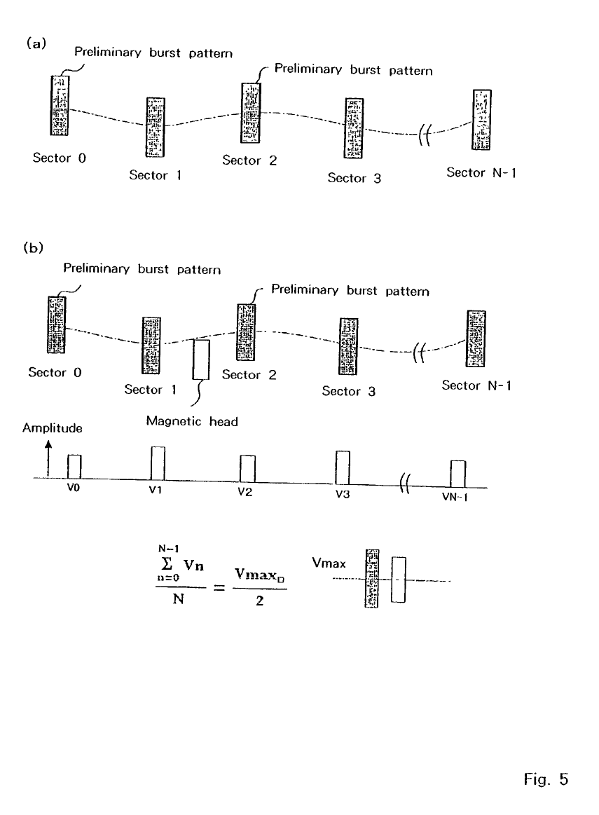

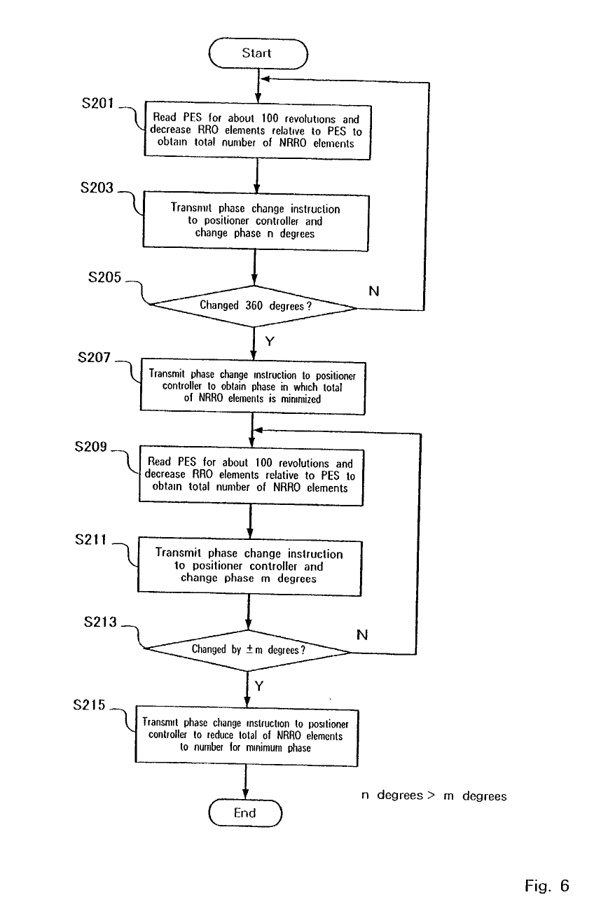

The servo data writing method of this embodiment will now be described while referring to FIGS. 4 to 6. FIG. 4 is a flowchart for explaining the servo data writing method according to the embodiment. FIGS. 5A and 5B are diagrams for explaining a specific method for detecting a position error signal in FIG. 4. And FIG. 6 is a flowchart showing the specific phase adjusting processing in FIG. 4. The essential part of the servo data writing method of the embodiment is that used to obtain the vibration of the magnetic disk 3 and to move the magnetic head 5 while following vibration in order to write servo data. Especially in this embodiment, vibration is acquired as a positional relationship between the magnetic disk 3 and the magnetic head 5.

According to the servo data writing method of this embodiment, first, a position error signal (PES) is detected (S101 in FIG. 4). The vibration of the magnetic head 5 that occurs when servo data is to be written is determined by performing the following process for the position error signal.

The PES is detected in the following manner. First, a preliminary burst pattern is written to the magnetic disk 3 using the magnetic head 5. While the magnetic head 5 is fixed at a predetermined position by the head positioner 9, the magnetic disk 3 is rotated at a predetermined speed by the spindle motor 4 to write the preliminary burst pattern. The preliminary burst pattern is written to only N sectors during one cycle of the magnetic disk 3.

In FIG. 5A are shown specific preliminary burst patterns that are written. Vibration of the magnetic disk 3 is caused by the writing of the preliminary burst patterns. This vibration includes an RRO element and an NRRO element. As is shown in FIG. 5A, the line that connects the widthwise centers of the preliminary burst patterns represents the NRRO element that is generated during the writing of the preliminary burst patterns. This NRRO element becomes an RRO element when the preliminary burst pattern is to be read.

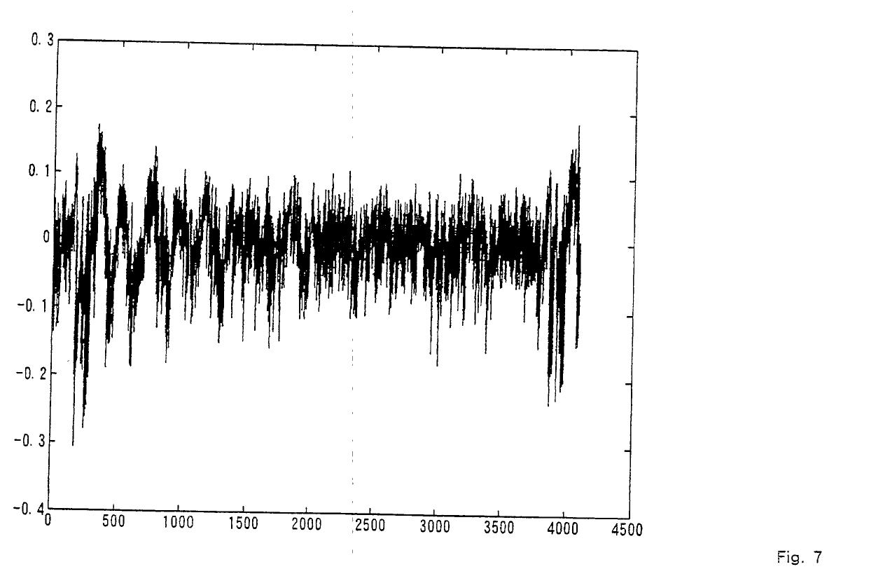

Next, the preliminary burst pattern is read by the magnetic head 5. At this time, the magnetic head 5 is so moved, as is indicated by the equation in FIG. 5B, that for one cycle the average value of the amplitude of a preliminary burst pattern read signal becomes ½ the maximum value of the amplitude. That is, the center of the magnetic head 5 is aligned with the edge of the preliminary burst pattern. Then, when the amplitude of a read signal becomes equal to the maximum value of the amplitude of the magnetic head 5, the position shift becomes ½ the width of the magnetic head 5. Further, when the amplitude of the read signal becomes 0 relative to the amplitude of the magnetic head 5, the position shift becomes ½ the width of the magnetic head 5. That is, the amplitude of the read signal can be specified in proportion to the width of the magnetic head 5. In this embodiment, the thus obtained amplitude of the read signal is used as a substitute for the PES. An example read signal is shown in FIG. 7.

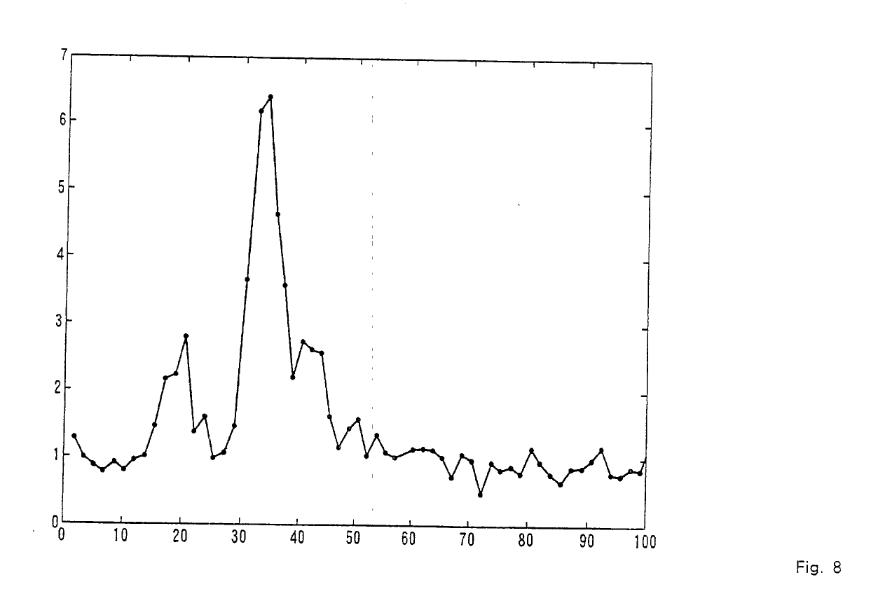

The preliminary burst patterns that are written using the above method are read during 100 revolutions of the magnetic disk 3, and an NRRO element produced during the writing of the preliminary burst patterns is employed to obtain the RRO element (S103 in FIG. 4). Then, the preliminary burst patterns are read within a range wherein the PES can be processed using a fast Fourier transform (FFT), and the waveform from which the RRO element is obtained at step S103 is decreased and is processed using a discrete Fourier transform (DFT), so that a frequency and the amplitude thereof are acquired (S105 in FIG. 4). An example frequency and an example amplitude that are thus obtained are shown in FIG. 8. These processes are performed by the recording controller 8.

The recording controller 8 transmits the obtained frequency and amplitude to the positioner controller 10 (S107 in FIG. 4). Then, the positioner controller 10 vibrates the head positioner 9 at the received frequency and amplitude (S109 in FIG. 4), and accordingly, the magnetic disk 3 is also vibrated. The frequency and the amplitude represent the positional relationship existing between the magnetic disk 3 and the magnetic head 5 during the rotation of the magnetic disk 3. This is true because the frequency and amplitude are based on the preliminary burst pattern that is read by the magnetic disk 3 when the magnetic head 5 is rotated. It should be noted that the writing of a servo pattern is not performed at this step. The writing of the servo pattern is initiated after the phases have been adjusted (S111 in FIG. 4).

The phase adjustment is performed as is shown in the flowchart in FIG. 6. During the phase adjustment processing, the magnetic head 5 reads, during 100 revolutions of the magnetic disk 3, the PES obtained at step S103 in FIG. 4, and the recording controller 8 decreases the RRO element from the PES, and calculates the total of the NRRO elements for 100 revolutions (S201 in FIG. 6). Then, the recording controller 8 transmits a phase change instruction to the positioner controller 10, and the positioner controller 10 permits the head positioner 9 to change the phase n degrees (S203 in FIG. 6). At this time, the magnetic head 5 is vibrated by the head positioner 9. The phase change process is the process employed to change the phase of the vibration of the magnetic head 5 every n degrees. The processes at steps S201 and S203 are repeated until 360 degrees are reached for the phase change (S205 in FIG. 6). The recording controller 8 transmits the phase change instruction to the positioner controller 10 to repeat the processes at steps S201 and S203 until 360 degrees are reached for the phase change, and to obtain the phase in which the total of the NRRO elements is minimized (S207 in FIG. 6). In this case, when the total of the NRRO elements is minimized, it means that the NRRO elements for the magnetic disk 3 completely or substantially match the phases of the NRRO elements that constitute the vibration of the magnetic head 5 whose phase has been changed every n degrees. In other words, this means that a predetermined synchronization can be obtained between the vibration of the magnetic disk 3 and the vibration of the magnetic head 5. Through this processing, the rough phase adjustments are terminated, and then, further detailed phase adjustments are initiated. The basic processing for detailed phase adjustments is the same as steps S201 to S207 in FIG. 6.

Specifically, the PES is read for 100 revolutions, and the RRO element is decreased from the PES to obtain the total number of NRRO elements (S209 in FIG. 6). Then, the phase change instruction is transmitted to the positioner controller 10 to change the phase n degrees (S211 in FIG. 6). At this time, n>m, and in the phase adjustments performed following S209, the phase adjustments performed before S207 are performed in more detail. Two process types are employed for the phase changes performed every m degrees, i.e., the phases are changed within a range extending from +m degrees to −m degrees (S213 in FIG. 6). If the phase change within the range of +m degrees has already been performed, the recording controller 8 transmits the phase change instruction to the positioner controller 10, so that in the changed phase the total number of the NRRO elements is minimized (S215 in FIG. 6).

The phase adjustments are thereafter ended, and in accordance with a received phase, the positioner controller 10 writes servo data, while vibrating the head positioner 9 at the received frequency and amplitude. This writing of servo data is continued until the last track of N predetermined tracks is reached (steps S113 and S115 in FIG. 4).

As is described above, according to the present invention, since the servo data write head can follow the vibration of the recording medium, the occurrence of a jump is avoided along the trajectory of the servo data that is written. At the same time, since the trajectory of the servo data can be regarded as being synchronized with the vibration of the recording medium, the probability whereat variations in the interval between adjacent tracks will occur will be extremely low.

What is claimed is:

1. A servo data writing apparatus for writing, via a write head, servo data that identifies the positions of multiple tracks formed on a recording medium having a disk shape comprising:
a positioner for, before writing said servo data, moving said write head in the radial direction of said recording medium; and
a controller for, when the position of said recording medium changes relative to the position of said write head as said recording medium is rotated, permitting said positioner to move said write head in said radial direction of said recording medium while said servo data is being written.

2. The servo data writing apparatus according to claim 1, wherein said controller controls said write head so as to write preliminary position data to said recording medium before the writing of said servo data is initiated.

3. The servo data writing apparatus according to claim 2, wherein said controller controls said positioner so as to write said preliminary position data to said recording medium, said write head is fixed in a predetermined location.

4. The servo data writing apparatus according to claim 2, wherein said controller reads said preliminary position data from said recording medium to obtain said positional relationship between said recording medium and said write head.

5. A servo data writing apparatus for writing servo data that identifies the positions of multiple tracks formed on a recording medium having a disk shape comprising:
a head for, before writing said servo data to said recording medium, writing a predetermined burst pattern on said recording medium, and for reading said burst pattern from said recording medium;
vibration detection means for employing said burst pattern read by said head to detect vibrations that occur as said recording medium is rotated, and for decreasing, from said detected vibration, the element of a synchronous vibration that is synchronized with the rotation of said recording medium to obtain an element of an asynchronous vibration that is not synchronized with the rotation of said recording medium; and
a controller for vibrating said head so as to follow said element of said asynchronous vibration that is detected by said detection means.

6. The servo data writing apparatus according to claim 5, wherein said vibration detection means employs said element of said asynchronous vibration to obtain the frequency and the amplitude of said asynchronous vibration; and wherein said controller vibrates said head based on said frequency and said amplitude that are obtained.

7. The servo data writing apparatus according to claim 5, wherein said controller adjusts the phase of said element of said asynchronous vibration of said recording medium that is rotated and the phase of said vibration at said head before permitting said head to write said servo data.

8. The servo data writing apparatus according to claim 7, wherein said controller adjusts said phases, so that the total of said element of said asynchronous vibration of said recording medium and said vibration of said head is minimized.

9. A servo data writing method for employing a head to write servo data that identifies the positions of multiple tracks formed on a recording medium having a disk shape comprising the steps of:
obtaining the positional relationship, in the radial direction of said recording medium, of a head and said recording medium that is rotated; and
controlling the positioning of said head in said radial direction in accordance with said positional relationship, and writing said servo data to said recording medium.

10. The servo data writing method according to claim 9, wherein preliminary position data is written while the position of said head is fixed in the radial direction, and said positional relationship is obtained by reading said preliminary position data.

11. The servo data writing method according to claim 10, wherein said preliminary position data is read to obtain a first vibration element that is caused by said recording medium when said preliminary data is written; and wherein a second vibration element that is synchronously caused by the rotation of said recording medium is then decreased relative to said first vibration element to obtain a third vibration element, and to obtain said positional relationship.

12. The servo data writing method according to claim 11, wherein said third vibration element is employed to obtain a frequency and an amplitude that represent said positional relationship existing in said radial direction between said head and said recording medium that is being rotated.

13. The servo data writing method according to claim 12, wherein to control the position of said head, a vibration generated at said frequency and said amplitude is provided for said head; and wherein said servo data be written while a predetermined synchronization is obtained between the vibration of said head and the vibration of said recording medium that is rotated.

14. A servo data writing method, for using a head to write servo data that identifies the positions of multiple tracks formed on a recording medium in a disk shape, comprising the steps of:
detecting a vibration caused by rotating said recording medium; and
writing said servo data while permitting said head to follow said vibration.

15. The servo data writing method according to claim 14, wherein said vibration to be followed includes a vibration that is not synchronized with the rotation of said recording medium.
